(19) United States
(12) Patent Application Publication
(10) Pub. No.: US 2002/0078985 A1
(43) Pub. Date: Jun. 27, 2002

(54) MIST-PRODUCING UMBRELLA DEVICE

(76) Inventor: Fariss Farr, Aliso Viejo, CA (US)

Correspondence Address: Kaardal & Associates, PC, Attn: Ivar M. Kaardal, Suite 250, 3500 South First Ave. Circle, Sioux Falls, SD, 57105-5802, US

(21) Appl. No.: 09/747,880

(22) Filed: Dec. 26, 2000

(51) Int. Cl. A45B 1/00; A45B 3/00; A45B 5/00; A45B 25/00; B05B 15/00; B05B 17/00

(52) U.S. Cl. 135/16; 135/31; 239/289

(57) ABSTRACT

A mist-producing umbrella device for providing a soothing and cooling mist for users on a hot day at a beach. The mist-producing umbrella device includes an umbrella assembly including an elongate tubular support member and a collapsible canopy mounted upon a top end of the elongate tubular support member; and also includes a water control assembly including a housing being removably attached to the elongate tubular support member, and also including a water reservoir being disposed in the housing, and further including a pump being disposed in the housing and being connected to the water reservoir; and further includes a mist-dispensing assembly including a conduit being connected to the housing, and also including tubular branch members being securely attached to the elongate tubular support member and extending radially therefrom.

### BACKGROUND OF THE INVENTION

1. Field of the Invention

The present invention relates to a mist-dispensing umbrella and more particularly pertains to a new mist-producing umbrella device for providing a soothing and cooling mist for users on a hot day at a beach.

2. Description of the Prior Art

The use of a mist-dispensing umbrella is known in the prior art. More specifically, a mist-dispensing umbrella heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 5,143,107; U.S. Pat. No. 5,000,384; U.S. Pat. No. 5,725,004; U.S. Pat. No. 5,349,974; U.S. Pat. No. Des. 416,073; and U.S. Pat. No. 5,299,588.

While these devices fulfill their respective, particular objectives and requirements, the aforementioned patents do not disclose a new mist-producing umbrella device. The inventive device includes an umbrella assembly including an elongate tubular support member and a collapsible canopy mounted upon a top end of the elongate tubular support member; and also includes a water control assembly including a housing being removably attached to the elongate tubular support member, and also including a water reservoir being disposed in the housing, and further including a pump being disposed in the housing and being connected to the water reservoir; and further includes a mist-dispensing assembly including a conduit being connected to the housing, and also including tubular branch members being securely attached to the elongate tubular support member and extending radially therefrom.

In these respects, the mist-producing umbrella device according to the present invention substantially departs from the conventional concepts and designs of the prior art, and in so doing provides an apparatus primarily developed for the purpose of providing a soothing and cooling mist for users on a hot day at a beach.

### SUMMARY OF THE INVENTION

In view of the foregoing disadvantages inherent in the known types of mist-dispensing umbrella now present in the prior art, the present invention provides a new mist-producing umbrella device construction wherein the same can be utilized for providing a soothing and cooling mist for users on a hot day at a beach.

The general purpose of the present invention, which will be described subsequently in greater detail, is to provide a new mist-producing umbrella device which has many of the advantages of the mist-dispensing umbrella mentioned heretofore and many novel features that result in a new mist-producing umbrella device which is not anticipated, rendered obvious, suggested, or even implied by any of the prior art mist-dispensing umbrella, either alone or in any combination thereof.

To attain this, the present invention generally comprises an umbrella assembly including an elongate tubular support member and a collapsible canopy mounted upon a top end of the elongate tubular support member; and also includes a water control assembly including a housing being removably attached to the elongate tubular support member, and also including a water reservoir being disposed in the housing, and further including a pump being disposed in the housing and being connected to the water reservoir; and further includes a mist-dispensing assembly including a conduit being connected to the housing, and also including tubular branch members being securely attached to the elongate tubular support member and extending radially therefrom.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new mist-producing umbrella device which has many of the advantages of the mist-dispensing umbrella mentioned heretofore and many novel features that result in a new mist-producing umbrella device which is not anticipated, rendered obvious, suggested, or even implied by any of the prior art mist-dispensing umbrella, either alone or in any combination thereof.

It is another object of the present invention to provide a new mist-producing umbrella device which may be easily and efficiently manufactured and marketed.

It is a further object of the present invention to provide a new mist-producing umbrella device which is of a durable and reliable construction.

An even further object of the present invention is to provide a new mist-producing umbrella device which is susceptible of a low cost of manufacture with regard to both materials and labor, and which accordingly is then susceptible of low prices of sale to the consuming public, thereby making such mist-producing umbrella device economically available to the buying public.

Still yet another object of the present invention is to provide a new mist-producing umbrella device which provides in the apparatuses and methods of the prior art some of the advantages thereof, while simultaneously overcoming some of the disadvantages normally associated therewith.

Still another object of the present invention is to provide a new mist-producing umbrella device for providing a soothing and cooling mist for users on a hot day at a beach.

Yet another object of the present invention is to provide a new mist-producing umbrella device which includes an umbrella assembly including an elongate tubular support member and a collapsible canopy mounted upon a top end of the elongate tubular support member; and also includes a water control assembly including a housing being removably attached to the elongate tubular support member, and also including a water reservoir being disposed in the housing, and further including a pump being disposed in the housing and being connected to the water reservoir; and further includes a mist-dispensing assembly including a conduit being connected to the housing, and also including tubular branch members being securely attached to the elongate tubular support member and extending radially therefrom.

Still yet another object of the present invention is to provide a new mist-producing umbrella device that can be attached and detached from the umbrella assembly quickly and easily.

Even still another object of the present invention is to provide a new mist-producing umbrella device that is totally self-contained.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side elevational view of a new mist-producing umbrella device according to the present invention.

FIG. 2 is a front elevational view of the housing of the present invention.

FIG. 3 is a top plan view of the housing of the present invention.

FIG. 4 is a detailed front elevational view of mist-dispensing members of the present invention.

FIG. 5 is a cross-sectional view of the elongate support member of the present invention.

FIG. 6 is a detailed perspective view of one of the mist-dispensing members of the present invention.

### DESCRIPTION OF THE PREFERRED EMBODIMENT

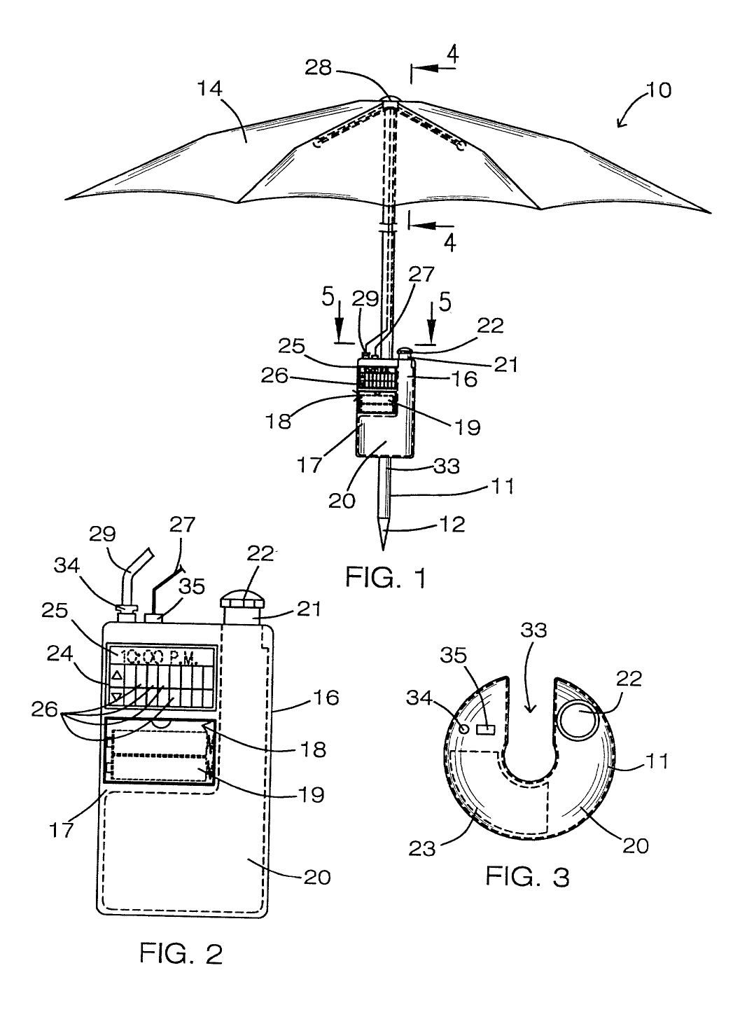

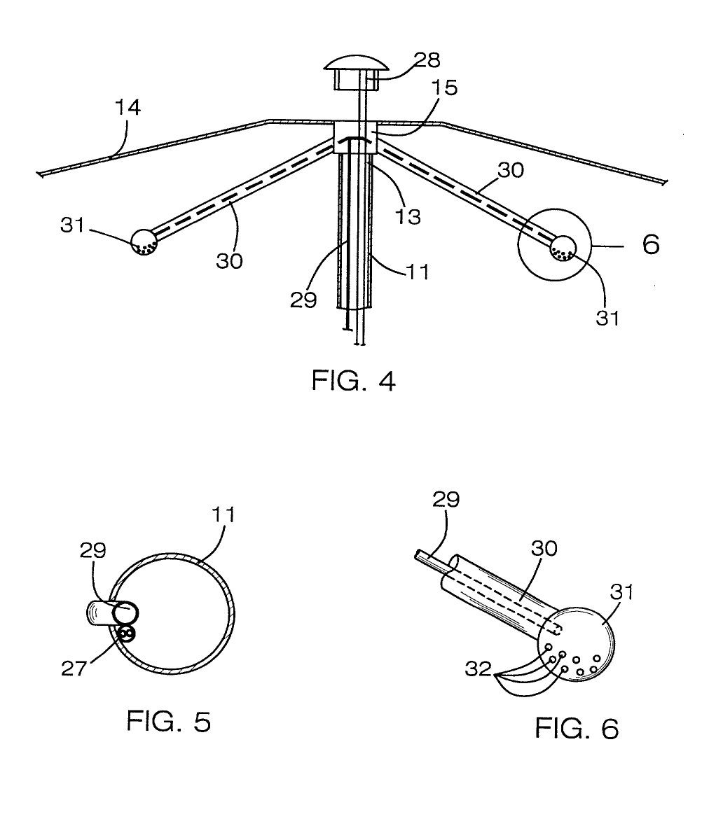

With reference now to the drawings, and in particular to FIGS. 1 through 6 thereof, a new mist-producing umbrella device embodying the principles and concepts of the present invention and generally designated by the reference numeral 10 will be described.

As best illustrated in FIGS. 1 through 6, the mist-producing umbrella device 10 generally comprises an umbrella assembly including an elongate tubular support member 11, a sleeve 15 being movably mounted to the elongate tubular support member 11, and a collapsible canopy 14 being conventionally mounted upon a top end 13 of the elongate tubular support member 11 and to the sleeve 15. The elongate tubular member 11 has a pointed bottom end 12 for penetrating into the ground. The canopy 14 is made of an ultraviolet-blocking fabric.

A water control assembly includes a housing 16 being removably attached to the elongate tubular support member 11, and also including a water reservoir 20 being conventionally disposed in the housing 16, and further includes a pump 23 being conventionally disposed in the housing 16 and being connected to the water reservoir 20. The water control assembly also includes a battery compartment 18 being disposed in the housing 16, and further includes a battery pack 19 being removably and conventionally disposed in the battery compartment 18 and being conventionally connected to the pump 23. The water control assembly also includes a timer mechanism 24 being conventionally disposed in the housing 16 and having a timer display screen 25 being conventionally disposed in a front wall 17 thereof, and further includes control switches 26 being securely and conventionally disposed in the front wall 17 of the housing 16 and being conventionally connected to the battery pack 19 and to the pump 23 for the energizing of the pump 23. The water control assembly further includes a solar cell 28 being removably and conventionally disposed in the top end 13 of the elongate tubular support member 11 and being connected to the battery pack 19 with wires 27 for the recharging of the battery pack 19. The wires 27 are disposed through the elongate tubular support member 11 and are conventionally connected to a plug member 35 which is removably received in a jack of the housing 16. The water control assembly also includes a spout 21 extending outwardly from the housing 16 and being extended into the water reservoir 20 for filling the water reservoir 20 with water, and further includes a cap member 22 being removably disposed upon the spout 21. The housing 16 is cylindrically-shaped and has a longitudinal slot 33 being disposed in a side wall thereof and extending a length of the housing 16. The longitudinal slot 33 is adapted to engagably receive a portion of the elongate tubular support member 11 for securely attaching the housing 16 to the elongate tubular support member 11.

A mist-dispensing assembly includes a conduit 29 being connected to the housing 16, and also includes tubular branch members 30 being securely and conventionally attached to the sleeve 15 and extending radially therefrom. The conduit 29 is connected to the housing 16 with a connecting adapter 34 and is conventionally connected to the pump 23 and also extends through a side wall of the elongate tubular support member 11 and further extends through the elongate tubular support member 11 and through the tubular branch members 30. The mist-dispensing assembly further includes nozzles 31 being securely and conventionally attached at ends of the tubular branch members 30 and having a plurality of holes 32 being disposed therein for allowing mist to be dispensed through the nozzles 31. The tubular branch members 30 are angled downwardly relative to the elongate tubular support member 11.

In use, the user would deploy the canopy 14 using the sleeve 15 and would set the timer mechanism 24 to the desired time during which mist would be dispensed through the nozzles 3 1, and then would turn on the control switches 26 to energize the pump 23 which urges water from the water reservoir 20 through the conduit 29 and through the holes 32 in the nozzles 31 to dispense a water mist to the user either lying or sitting beneath the canopy 14.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mist-dispensing umbrella device comprising:
an umbrella assembly including an elongate tubular support member, a sleeve being movably mounted to said elongate tubular support member, and a collapsible canopy mounted upon a top end of said elongate tubular support member and to said sleeve;
a water control assembly including a housing being removably attached to said elongate tubular support member, and also including a water reservoir being disposed in said housing, and further including a pump being disposed in said housing and being connected to said water reservoir; and
a mist-dispensing assembly including a conduit being connected to said housing, and also including tubular branch members being securely attached to said sleeve and extending radially therefrom.

2. A mist-dispensing umbrella device as described in claim 1, wherein said canopy is made of an ultraviolet-blocking fabric.

3. A mist-dispensing umbrella device as described in claim 1, wherein said water control assembly also includes a battery compartment disposed in said housing, and further includes a battery pack being removably disposed in said battery compartment and being connected to said pump.

4. A mist-dispensing umbrella device as described in claim 3, wherein said water control assembly also includes a timer mechanism being disposed in said housing and having a timer display screen being disposed in a front wall thereof, and further includes control switches being securely disposed in said front wall of said housing and being connected to said battery pack and to said pump for the energizing of said pump.

5. A mist-dispensing umbrella device as described in claim 4, wherein said water control assembly further includes a solar cell being removably disposed in a top end of said elongate tubular support member and being connected to said battery pack with wires, said wires being disposed through said elongate tubular support member and being connected to a plug member which is removably received in a jack of said housing.

6. A mist-dispensing umbrella device as described in claim 5, wherein said water control assembly also includes a spout extending outwardly from said housing and being extended into said water reservoir for filling said water reservoir with water, and further includes a cap member being removably disposed upon said spout.

7. A mist-dispensing umbrella device as described in claim 6, wherein said housing is cylindrically-shaped and has a longitudinal slot being disposed in a side wall thereof and extending a length of said housing, said longitudinal slot being adapted to engagably receive a portion of said elongate tubular support member for securely attaching said housing to said elongate tubular support member.

8. A mist-dispensing umbrella device as described in claim 1, wherein said conduit is connected to said housing with a connecting adapter and is connected to said pump and also extends through a side wall of said elongate tubular support member and further extends in said elongate tubular support member to near said top end thereof and is connected to said tubular branch members.

9. A mist-dispensing umbrella device as described in claim 8, wherein said mist-dispensing assembly further includes nozzles being securely attached at ends of said tubular branch members and having a plurality of holes being disposed therein for allowing mist to be dispensed through said nozzles.

10. A mist-dispensing umbrella device as described in claim 9, wherein said tubular branch members are angled downwardly relative to said elongate tubular support member.

11. A mist-dispensing umbrella device comprising:
an umbrella assembly including an elongate tubular support member, a sleeve being movably mounted to said elongate tubular support member, and a collapsible canopy mounted upon a top end of said elongate tubular support member and to said sleeve, said canopy being made of an ultraviolet-blocking fabric;
a water control assembly including a housing being removably attached to said elongate tubular support member, and also including a water reservoir being disposed in said housing, and further including a pump being disposed in said housing and being connected to said water reservoir, said water control assembly also including a battery compartment disposed in said housing, and further including a battery pack being removably disposed in said battery compartment and being connected to said pump, said water control assembly also including a timer mechanism being disposed in said housing and having a timer display screen being disposed in a front wall thereof, and further including control switches being securely disposed in said front wall of said housing and being connected to said battery pack and to said pump for the energizing of said pump, said water control assembly further including a solar cell being removably disposed in a top end of said elongate tubular support member and being connected to said battery pack with wires for the recharging of said battery pack, said wires being disposed through said elongate tubular support member and being connected to a plug member which is removably received in a jack of said housing, said water control assembly also including a spout extending outwardly from said housing and being extended into said water reservoir for filling said water reservoir with water, and further including a cap member being removably disposed upon said spout, said housing being cylindrically-shaped and having a longitudinal slot being disposed in a side wall thereof and extending a length of said housing, said longitudinal slot being adapted to engagably receive a portion of said elongate tubular support member for securely attaching said housing to said elongate tubular support member; and
a mist-dispensing assembly including a conduit being connected to said housing, and also including tubular branch members being securely attached to said sleeve and extending radially therefrom, said conduit being connected to said housing with a connecting adapter and being connected to said pump and also extending through a side wall of said elongate tubular support member and further extending in said elongate tubular support member to near said top end thereof and being connected to said tubular branch members, said mist-dispensing assembly further including nozzles being securely attached at ends of said tubular branch members and having a plurality of holes being disposed therein for allowing mist to be dispensed through said nozzles, said tubular branch members being angled downwardly relative to said elongate tubular support member.
